(19) United States
(12) Patent Application Publication
(10) Pub. No.: US 2026/0307559 A1
(43) Pub. Date: Oct. 8, 2026

(54) VEHICLE

(71) Applicant: KAWASAKI MOTORS, LTD., Akashi-Shi (JP)

(72) Inventor: Kazuki ISHIBASHI, Akashi-Shi (JP)

(73) Assignee: KAWASAKI MOTORS, LTD., Akashi-Shi (JP)

(21) Appl. No.: 19/171,454

(22) Filed: Apr. 7, 2025

(51) Int. Cl. B60N 2/36; B62D 33/033; B62D 33/08

(52) U.S. Cl. CPC B60N 2/36; B62D 33/033; B62D 33/08; B60N 2002/363

(57) ABSTRACT

A vehicle includes a front footrest, a front seat, a rear seat, and a partition mount. A seating surface of the rear seat is located rearward of the front seat. The rear seat is switchable between a stowed position at which an occupant is capable of being seated thereon and a deployed position located rearward of the stowed position. A partition fence that partitions the rear seat at the deployed position is mountable to the partition mount.

### TECHNICAL FIELD

The present disclosure relates to vehicles.

### BACKGROUND ART

U.S. Pat. No. 7,416,238 B2 discloses a vehicle including a rear seat convertible to a cargo bed.

### SUMMARY

The vehicle includes: a front footrest; a front seat located rearward of the front footrest and including a seating surface located above the front footrest; a rear seat including a seating surface located rearward of the front seat, the rear seat being switchable between a stowed position at which an occupant is capable of being seated thereon and a deployed position located rearward of the stowed position; and a partition mount to which a partition fence that partitions the rear seat at the deployed position is mountable.

These and other objects, features, aspects and advantages of the present disclosure will become more apparent from the following detailed description when taken in conjunction with the accompanying drawings.

### BRIEF DESCRIPTION OF DRAWINGS

FIG. 1 is a side view illustrating a vehicle.

FIG. 2 is a side view illustrating the vehicle with a rear seat at a deployed position.

FIG. 3 is a perspective view illustrating a rear portion of the vehicle.

FIG. 4 is a perspective view illustrating the rear portion of the vehicle with the rear seat at the deployed position.

FIG. 5 is a perspective view illustrating mounting of a fence member.

FIG. 6 is a perspective view illustrating the fence member having been mounted.

FIG. 7 is a perspective view illustrating a clamp.

FIG. 8 is a perspective view illustrating the rear portion of the vehicle with a base panel removed.

FIG. 9 is a perspective view illustrating the rear portion of the vehicle with a rear seat support frame removed.

FIG. 10 is a diagram for describing mounting of the clamp to a rail structure.

FIG. 11 is a plan view illustrating mounting of partition walls to armrests.

### DESCRIPTION OF THE PREFERRED EMBODIMENTS

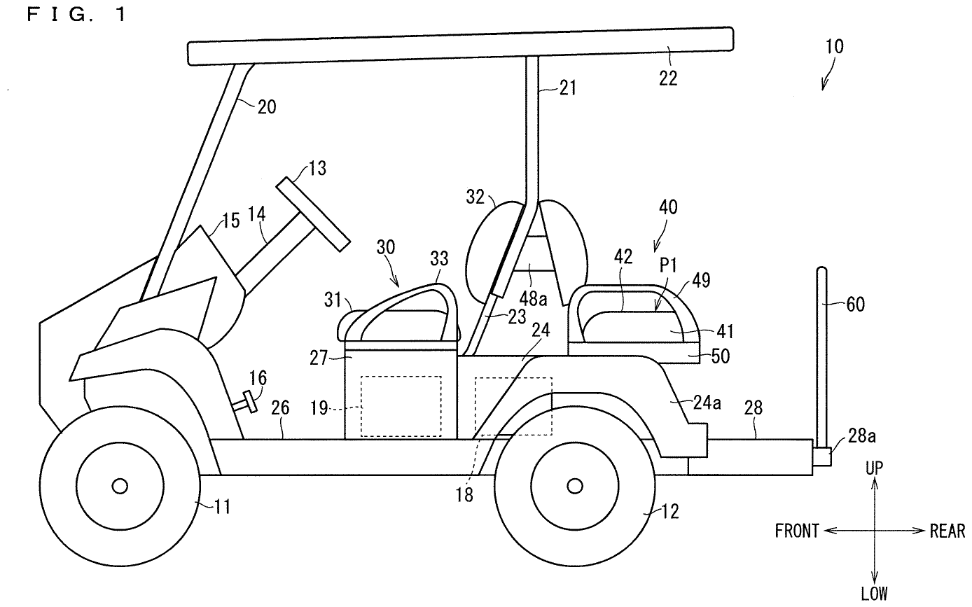

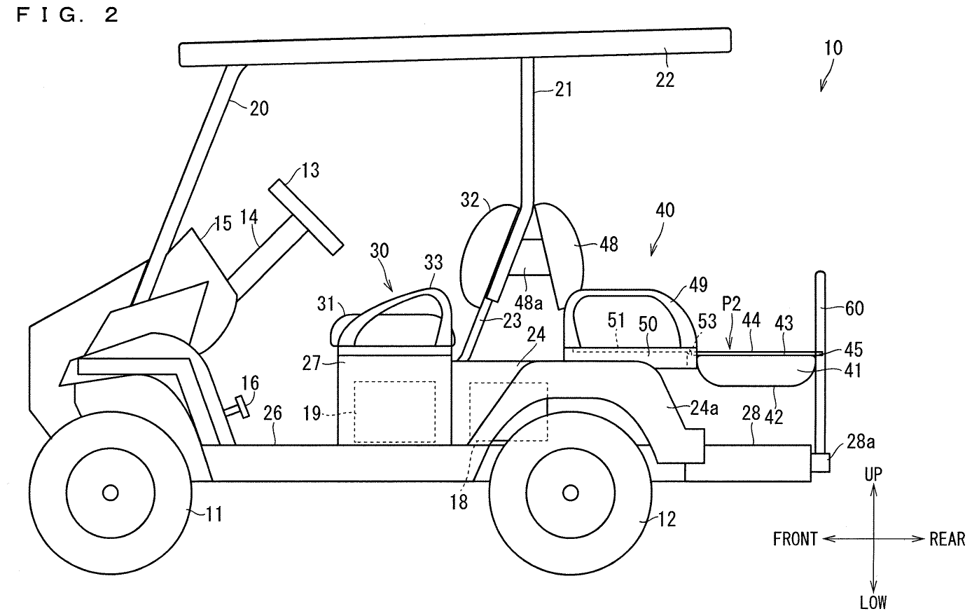

A vehicle according to an embodiment will be described below. FIG. 1 is a side view illustrating a vehicle 10. FIG. 2 is a side view illustrating the vehicle 10 with a rear seat 40 at a deployed position P2.

In description made below, a direction of travel of the vehicle 10 is also referred to as FRONT, a direction opposite FRONT is also referred to as REAR, a direction toward a travel surface is also referred to as LOW, and a direction opposite LOW is also referred to as UP. The travel surface is the ground or a road, for example. LEFT and RIGHT are sometimes referred to in a state of facing forward while standing on the travel surface. A LEFT-RIGHT direction is a vehicle width direction.

The vehicle 10 may be a passenger transport vehicle intended to travel in a limited area at a low speed.

The limited area may be a limited community area and a private road or private property (e.g., a golf course and a park), for example. The limited community area is an area used by local residents. The community area is an area including houses and public facilities (e.g., a school, a hospital), for example, and is an area in which a vehicle not intended to travel on a public road is allowed to travel at a low speed. The low speed is a speed up to 20 mph to 30 mph, for example. The vehicle 10 includes a personal transport vehicle (PTV) of ANSI/ILTVA Z135 and a golf car of ANSI/ILTVA Z130.1. The vehicle 10 also includes a personal transportation electric vehicle.

The vehicle 10 is a conveyance that travels on a travel surface. The vehicle 10 may be an off-road vehicle, for example. The off-road vehicle may be a versatile small-sized vehicle more suitable for off-road travel than travel on a public road at a high speed.

The off-road vehicle includes a side-by-side vehicle, for example. The side-by-side vehicle is a small-sized vehicle suitable for all-terrain travel, for example, and is a vehicle in which occupants can be seated side by side. The side-by-side vehicle may be a multipurpose off-highway utility vehicle (MOHUV) defined by ANSI/OPEI B71.9-2016 and a recreational off-highway vehicle defined by ANSI/ROHVA 1-2016.

The vehicle 10 includes a front footrest 26, a front seat 30, a rear seat 40, and a partition mount. The front footrest 26, the front seat 30, and the rear seat 40 are arranged in this order from the front.

The front footrest 26 expands forward of the front seat 30 in a front-rear direction. The front footrest 26 expands horizontally.

The front seat 30 is located rearward of the front footrest 26. The front seat 30 includes a front seating surface 31. The front seating surface 31 is located above the front footrest 26. The front footrest 26 is a portion to rest the feet of an occupant seated on the front seating surface 31 while facing forward. In the present embodiment, the front seat 30 includes a driver's seat. The front seat 30 may include a passenger's seat. The front seating surface 31 may be a bench seat extending from near a left end to near a right end along the vehicle width direction. The driver's seat and the passenger's seat have been integrated in the bench seat. The front seat 30 may be separate seats in which the driver's seat and the passenger's seat are separated.

The rear seat 40 includes a rear seating surface 42. The rear seating surface 42 is located rearward of the front seat 30. The rear seating surface 42 is a bench seat extending from near a left end to near a right end along the vehicle width direction. In the present embodiment, people can be seated on the rear seating surface 42 side by side in the vehicle width direction. The rear seating surface 42 may be separate seats. As illustrated in FIGS. 1 and 2, the rear seat 40 is switchable between a stowed position P1 and a deployed position P2. The stowed position P1 is a position at which an occupant can be seated. The deployed position P2 is a position rearward of the stowed position P1. More precisely, a rear end at the deployed position P2 is located rearward of a rear end at the stowed position P1. A front end at the deployed position P2 is located rearward of a front end at the stowed position P1. There may be a portion at the stowed position P1 and a portion at the deployed position P2 overlapping each other in the front-rear direction.

The rear seat 40 is located at the stowed position P1, so that the rear seat 40 is stowed. In this case, an occupant can be seated on the rear seat 40. In a case where the rear seat 40 is located at the stowed position P1, the rear seat 40 is located forward compared with a case where the rear seat 40 is located at the deployed position P2. The stowed position P1 is located forward of a rear footrest 28, which will be described below. At least portion at the deployed position P2 overlaps the rear footrest 28 in a vertical direction in top view. In other words, a rear end at the deployed position P2 is located rearward of a front end of the rear footrest 28. The rear seat 40 is located at the deployed position P2, so that the rear seat 40 is a portion of a cargo bed. In this case, cargo can be loaded on the rear seat 40. In the present embodiment, the cargo bed includes the rear seat 40 located at the deployed position and a region forward of the rear seat 40 located at the deployed position. Thus, in a case where the rear seat 40 is located at the deployed position, the vehicle 10 has an expanded area of the cargo bed as both the stowed position P1 and the deployed position P2 function as a cargo bed space.

The partition mount is a portion to which a partition fence is mountable. The partition fence partitions the rear seat 40 at the deployed position P2. The partition fence functions as a restricting member that restricts movement and a fall of cargo disposed in the cargo bed space. The partition fence may be in the form of a frame including a combination of rod members. The partition fence may alternatively be in the form of a grid or a wall. The partition fence may be realized with a metal material or may be realized with a synthetic resin material. The partition fence is only required to be able to restrict movement of the cargo and may be a structure having flexibility and stretchability, such as a net and a rope. In the present embodiment, the partition fence is mountable to the partition mount at least in a case where the rear seat 40 is located at the deployed position P2. In other words, the partition fence may be dismountable from a vehicle body in a case where the rear seat 40 is located at the stowed position P1. The partition fence is dismounted from the vehicle body, so that interference between the partition wall and an occupant can be prevented. This facilitates operation of the occupant to enter and exit the rear seat 40.

In the present embodiment, the vehicle 10 includes the rear footrest 28. The rear footrest 28 is located rearward of the rear seat 40 at the stowed position P1 in the front-rear direction. The rear footrest 28 is located below the rear seating surface 42 in the vertical direction. The rear footrest 28 expands horizontally. The rear footrest 28 is a portion to rest the feet of an occupant seated on the rear seating surface 42 while facing rearward. The rear footrest 28 is located rearward of rear wheels 12. In the present embodiment, a rear end of the rear footrest 28 is located rearward of a rear end of a roof 22. The rear footrest 28 is disposed to oppose rear entrances opened outward in the left-right direction to allow entry to and exit from the rear seat 40. In other words, the rear entrances are located outward in the vehicle width direction of the rear footrest 28. In the present example, the rear entrances are arranged rearward of the rear wheels 12 on opposite sides in the left-right direction of the vehicle body. In the present example, the rear entrances are also located rearward of outward ends in the vehicle width direction of the rear footrest 28. Openings of the rear entrances can thus be increased in size to facilitate entry and exit of the occupant.

The front footrest 26, the rear footrest 28, the front seat 30, and the rear seat 40 are portions of the vehicle body, for example. The vehicle body is a support structure that supports each part of the vehicle 10 and supports an occupant or cargo. The vehicle body may have a monocoque structure or may have a ladder frame structure. The vehicle body includes a floor, for example.

The floor expands below a space for occupants in the vehicle 10. The floor is located above a road surface. The floor includes a combination of elongated members, for example. The elongated members are metal members, for example. The elongated members may be straight or may be curved. The elongated members may be pipe members, may be a planar members, or may be members U-shaped in cross section. The elongated members may be connected by welding or may be connected by screwing, for example. The floor includes a surface to support the feet of an occupant on board and to rest the feet of an occupant during entry and exit for movement. The floor includes a planar portion expanding horizontally. The floor may include a floorboard. Portions of the floor are the front footrest 26 and the rear footrest 28.

The vehicle 10 also includes front wheels 11, the rear wheels 12, a steering device, and a driving device.

For example, support frames extend from a front portion and a rear portion of the floor. Two front wheels 11 are rotatably supported by a support frame extending from the front portion of the floor. The front wheels 11 are located forward of the front footrest 26. The front wheels 11 may be supported to be rotatable around a steering axis in the vertical direction or in a direction tilted relative to the vertical direction. The number of front wheels 11 may be one. Two rear wheels 12 are rotatably supported by a support frame extending from the rear portion of the floor. The rear wheels 12 are located rearward of the floor.

The steering device includes a steering wheel 13, for example. The steering wheel 13 is located rearward of the front wheels 11. The steering wheel 13 is rotatably supported by a steering shaft 14. The steering wheel 13 is located above the front footrest 26. The steering wheel 13 is located forward of the driver's seat of the front seat 30. A driver seated on the driver's seat operates the steering wheel 13. The steering shaft 14 is connected to the front wheels 11 via a steering gear and the like. The front wheels 11 are rotated around the steering axis by operation of the steering wheel 13. The front wheels 11 are rotated around the steering axis to change the direction of travel of the vehicle 10.

An instrument panel 15 on which a speedometer, a battery level, and the like are displayed may be disposed forward of the steering wheel 13. The steering device may include operation pedals 16. The operation pedals 16 may be located below the steering wheel 13. The operation pedals 16 are a brake pedal and an accelerator pedal that can control a start, acceleration, deceleration, and a stop by adjusting a degree of depression thereof, for example.

The driving device includes a motor 18 for travel. The motor may be an electric motor or may be an internal combustion engine. A rotational shaft of the motor 18 is connected to a shaft of the rear wheels 12 directly or via a gear. Rotational drive force of the internal combustion engine is transmitted to the rear wheels 12 to allow the vehicle 10 to travel. The motor 18 may be located between the front seat 30 and the rear seat 40 in the front-rear direction, for example. The motor 18 may be located between the two rear wheels 12 in the vehicle width direction. The motor 18 may be located between the floor and the front seating surface 31 in the vertical direction. In a case where the motor 18 is the electric motor, the vehicle 10 includes a travel battery 19 that supplies a power supply to the electric motor. The travel battery may be located below the front seat 30, for example.

The vehicle 10 may include a cover. The cover covers a frame and the like of the vehicle body, for example. The cover may be located in a front portion of the vehicle 10. The cover may be located in a rear portion of the vehicle 10. In the present embodiment, the vehicle 10 includes a rear cover 24. The rear cover 24 includes left and right wheelhouses 24a. The left wheelhouse 24a is located at a left end of the rear cover 24 and covers a left rear wheel 12. The right wheelhouse 24a is located at a right end of the rear cover 24 and covers a right rear wheel 12. The rear cover 24 includes an intermediate cover portion 24b located between the left and right wheelhouses 24a along the vehicle width direction. The intermediate cover portion 24b covers the motor 18, for example.

The vehicle 10 may include the roof 22 that covers the front seat 30 and the rear seat 40 from above. The roof 22 may be supported at a position above and away from the front seat 30 and the rear seat 40 by a front pillar 20 and a rear pillar 21. The front pillar 20 and the rear pillar 21 may be located on each of a left side and a right side.

The front seat 30 may include a front backrest 32 and a front armrest 33 in addition to the front seating surface 31. The front backrest 32 is located rearward of the front seating surface 31 and protrudes above the front seating surface 31. An occupant seated on the front seating surface 31 while facing forward can rest his/her back onto the front backrest 32. The front backrest 32 supports the back of the occupant seated on the front seating surface 31 while facing forward from behind. The occupant seated on the front seating surface 31 while facing forward can rest his/her elbow onto the front armrest 33. The front armrest 33 may be located on each of a left side and a right side of the front seating surface 31.

The vehicle body includes a vertical frame 23 located rearward of the front seating surface 31 and extending in the vertical direction. A lower end of the rear pillar 21 is connected to an upper end of the vertical frame 23. The front backrest 32 is supported by the vertical frame 23 or the rear pillar 21. The vertical frame 23 may be located on each of a left side and a right side.

The vehicle body may include a front seating surface support 27 located between the front footrest 26 and the rear footrest 28 and protruding above the front footrest 26 and the rear footrest 28. The front seating surface support 27 supports the front seating surface 31 from below. The travel battery 19 may be stowed in the front seating surface support 27.

The rear seat 40 may include a rear backrest 48 and a rear armrest 49 in addition to the rear seating surface 42. The rear backrest 48 is located forward of the rear seating surface 42 and protrudes above the rear seating surface 42. An occupant seated on the rear seating surface 42 while facing rearward can rest his/her back onto the rear backrest 48. The rear backrest 48 supports the back of the occupant seated on the rear seating surface 42 while facing forward from behind. At least portion of the rear seat 40 may be disposed at the same position in the front-rear direction as the rear wheels 12 in side view. In the present embodiment, a portion of the rear seat 40 is located at a position in the front-rear direction at which upper ends of the rear wheels 12 are located. Toes of an occupant entering the rear seat 40 located at the stowed position P1 are to be located rearward of the rear wheels 12.

The occupant seated on the rear seating surface 42 while facing rearward can rest his/her elbow onto the rear armrest 49. The rear armrest 49 may be located on each of a left side and a right side of the rear seating surface 42. The armrest 49 is located outward in the vehicle width direction of the rear seating surface 42 and functions as a movement blocking member that blocks movement outward in the left-right direction of the occupant seated on the rear seat 40. The rear armrest 49 thus protrudes above the rear seating surface 42. A portion of the rear armrest 49 higher than an upper end of the rear seating surface 42 extends in the front-rear direction. In the present embodiment, the portion of the rear armrest 49 higher than the upper end of the rear seating surface 42 extends from a front end to a rear end of the rear seating surface 42 in the front-rear direction. A rear end of the rear armrest 49 is located forward of the front end of the rear footrest 28.

The rear backrest 48 may be supported by the vertical frame 23 or the rear pillar 21 that supports the front backrest 32. The rear backrest 48 may be supported by the vertical frame 23 or the rear pillar 21 via a support member 48a protruding forward from the rear backrest 48.

For example, the rear seating surface 42 may have a width to allow two or three occupants to be seated side by side thereon. The rear seating surface 42 may have a width of 1 m or more or may have a width of 1.2 m or more, for example. The rear seating surface 42 may have a width that is 80% or more of an overall width of the vehicle body, for example. The rear backrest 48 may have substantially the same width as the rear seating surface 42. The rear backrest 48 may be divided into sections.

The vehicle 10 may include a seat other than the front seat 30 and the rear seat 40. For example, the vehicle 10 may include three seats arranged in the front-rear direction. The configurations of the front seat 30 and the rear seat 40 described above may be applied to a front seat and an intermediate seat of the three seats. In this case, the vehicle includes the front seat 30 and the rear seat 40 described above and a seat rearward of the rear seat 40. The configurations of the front seat 30 and the rear seat 40 described above may be applied to the intermediate seat and a rear seat of the three seats. In this case, the vehicle includes the front seat 30 and the rear seat 40 described above and a seat forward of the front seat 30.

The vehicle 10 may include a guard 60. The guard 60 is located rearward of the rear seat 40. The guard 60 suppresses a fall of an occupant seated on the rear seat 40. The guard 60 extends upward from the rear end of the rear footrest 28. A lower end of the guard 60 is connected to brackets 28a located at the rear end of the rear footrest 28. The guard 60 includes a held part that can be held by the occupant seated on the rear seat 40. The held part extends in the left-right direction at a position higher than the upper end of the rear seating surface 42. Outward ends in the left-right direction of the guard 60 are located inward in the vehicle width direction of the outward ends in the left-right direction of the rear footrest 28. The guard 60 may have a dimension in the left-right direction greater than half a dimension in the left-right direction of the rear seating surface 42. Two occupants seated on the rear seating surface 42 side by side can thus easily hold the held part of the guard 60.

The vehicle 10 does not include a body and a door covering a left side and a right side of the vehicle body. Openings for entry and exit are thus always open outward in the vehicle width direction of a space between the front footrest 26 and the rear footrest 28. Thus, an occupant entering and exiting the front seat 30 can enter through one of the left and right openings for entry and exit, pass through a space above the front footrest, and exit through the other one of the left and right openings for entry and exit. An occupant entering and exiting the rear seat 40 can enter through one of the left and right openings for entry and exit, pass through a space above the rear footrest 28, and exit through the other one of the left and right openings for entry and exit.

The openings for entry and exit being always open refers to the openings for entry and exit being open without being blocked by a door or a wall preventing entry and exit. The openings for entry and exit may thus be covered with a soft sheet for weather protection, for example.

### Structure of Rear Portion of Vehicle

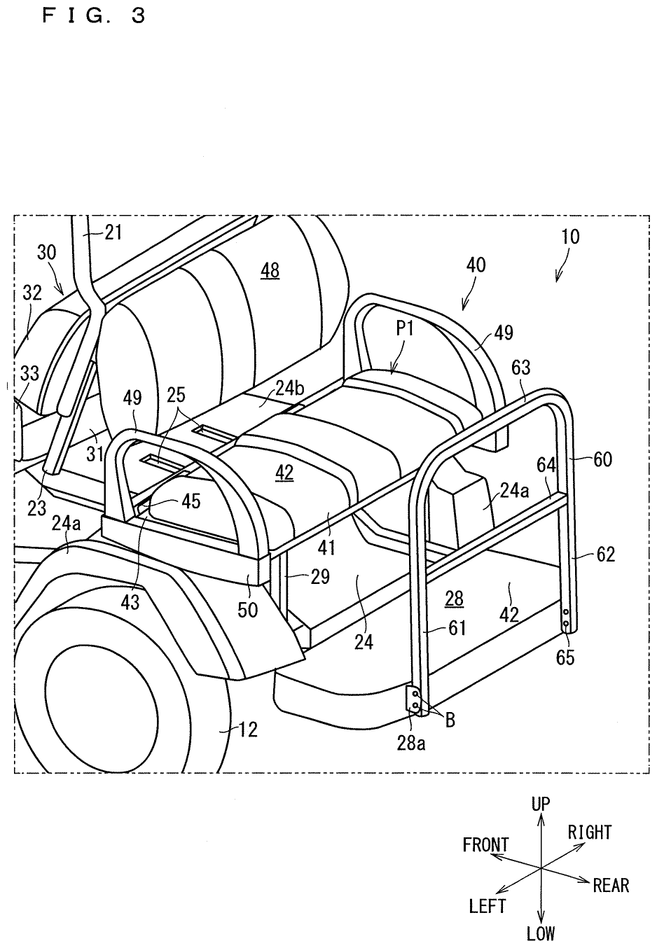

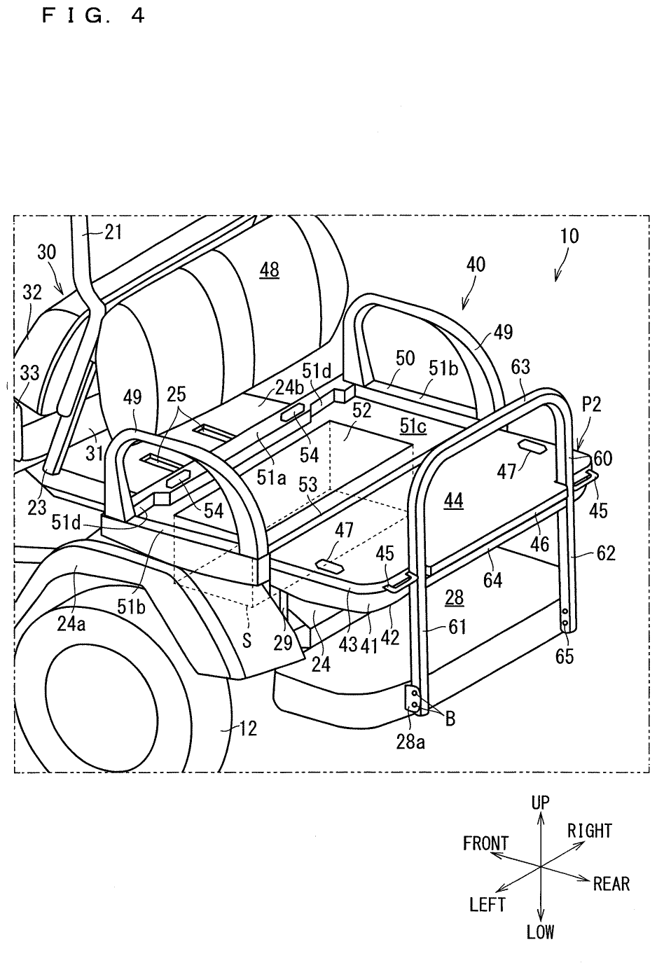

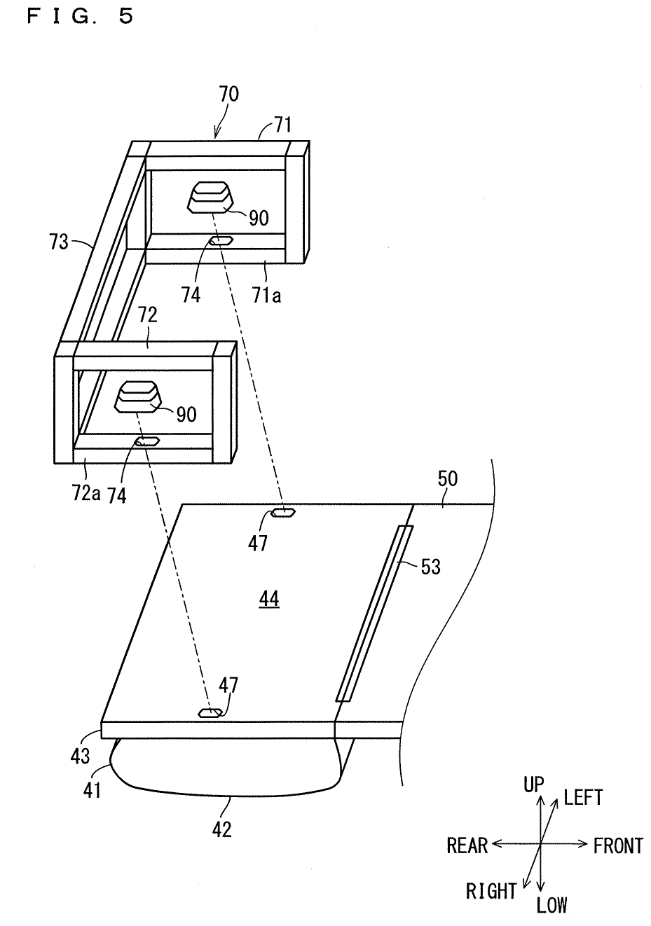

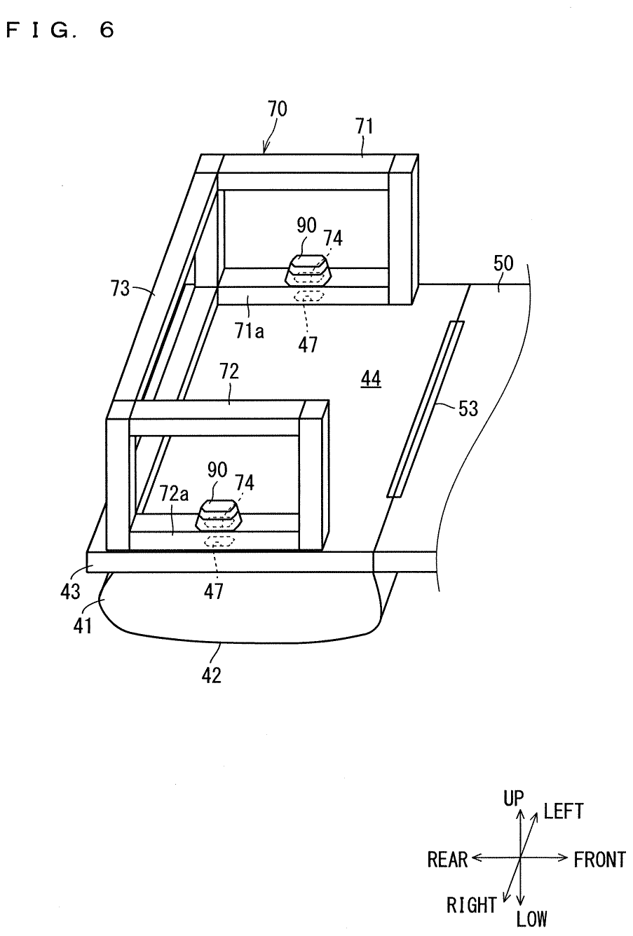

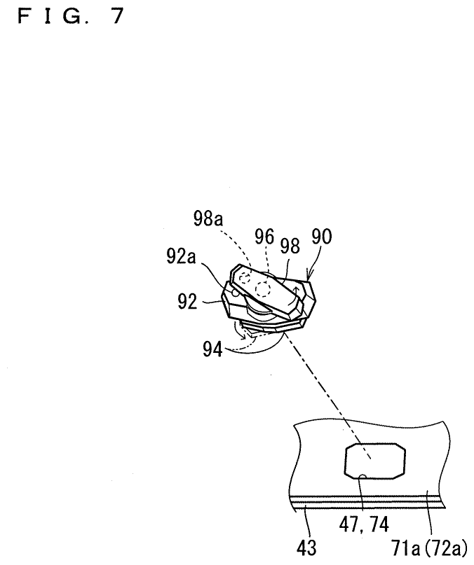

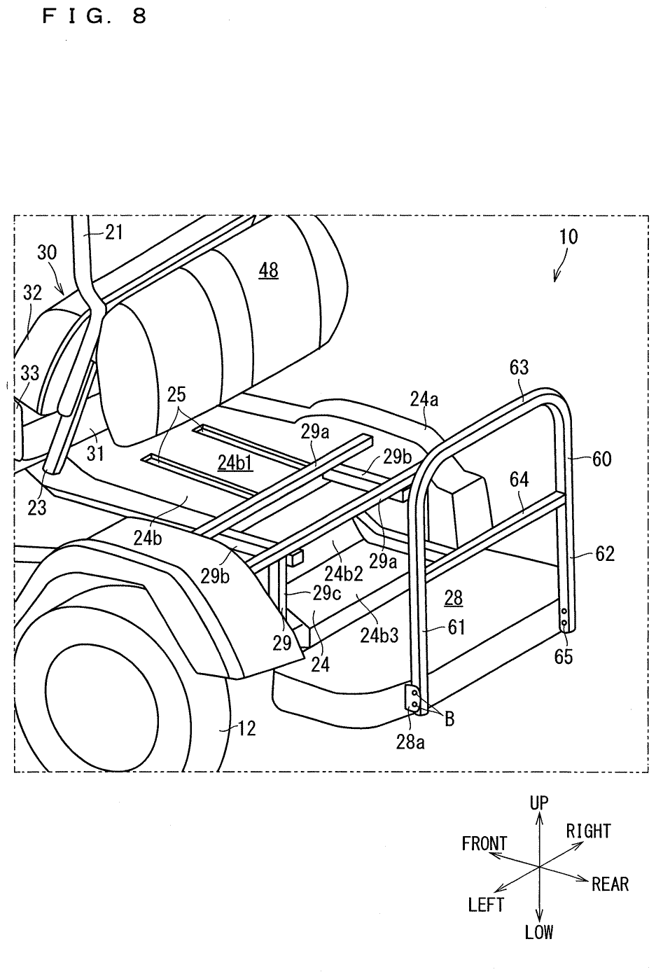

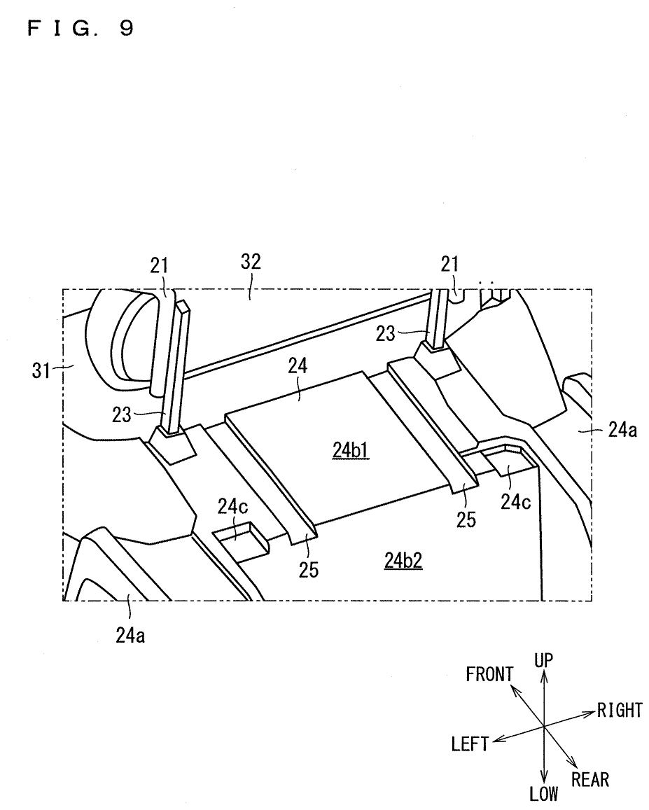

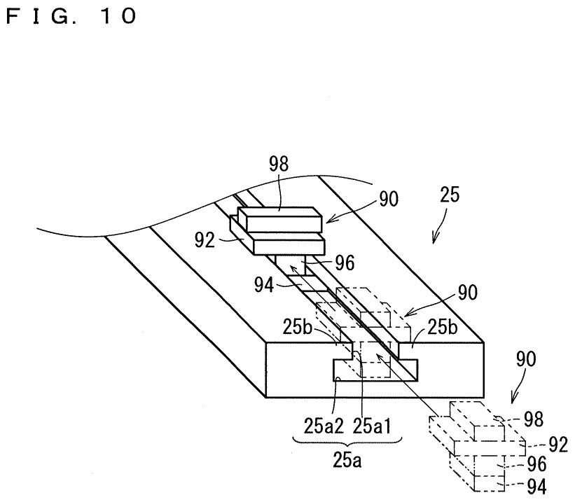

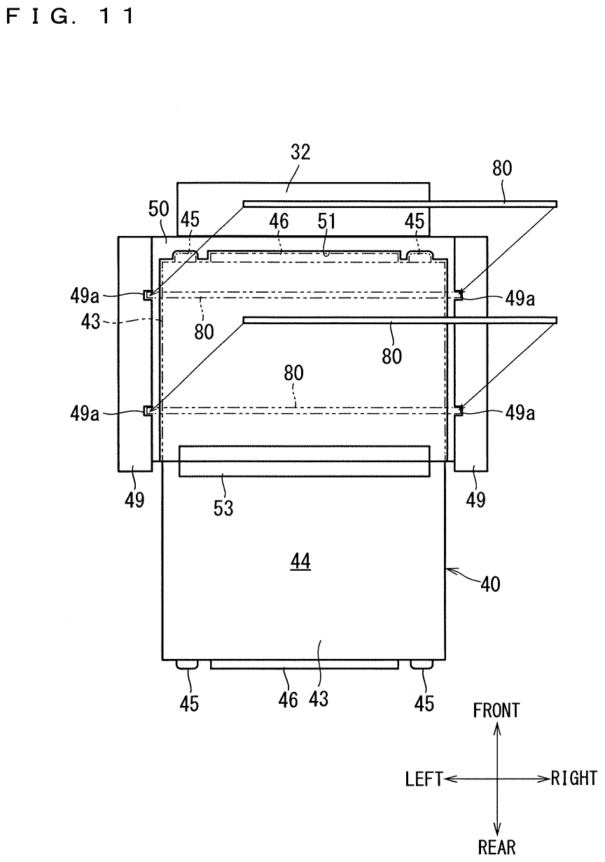

A structure of the rear portion of the vehicle 10 will be described further with reference to FIGS. 3 to 11. FIG. 3 is a perspective view illustrating the rear portion of the vehicle 10. FIG. 4 is a perspective view illustrating the rear portion of the vehicle 10 with the rear seat 40 at the deployed position P2. FIG. 5 is a perspective view illustrating mounting of a fence 70. FIG. 6 is a perspective view illustrating the fence 70 having been mounted. In each of FIGS. 5 and 6, a frame 51 of a base panel 50 is omitted. FIG. 7 is a perspective view illustrating a clamp 90. FIG. 8 is a perspective view illustrating the rear portion of the vehicle 10 with the base panel 50 removed. FIG. 9 is a perspective view illustrating the rear portion of the vehicle 10 with a seating surface support frame 29 removed. FIG. 10 is a diagram for describing mounting of the clamp 90 to a rail structure 25. FIG. 11 is a plan view illustrating mounting of partition walls 80 to armrests 49.

In the present embodiment, the rear seat 40 is moved between the stowed position P1 and the deployed position P2 by a pivot structure. The rear seat 40 is angularly displaceable around a rotational axis. The rotational axis extends in the vehicle width direction. In the present embodiment, the rotational axis is located at the rear end of the rear seat 40 at the stowed position P1 and extends in the vehicle width direction. The rear seat 40 is angularly displaced around the rotational axis to change an orientation of the rear seating surface 42. For example, the rear seating surface 42 faces downward at the deployed position P2. The amount of angular displacement between the stowed position Pl and the deployed position P2 is not particularly limited and can be set as appropriate. The amount of angular displacement between the stowed position P1 and the deployed position P2 is herein 180°.

The rear seat 40 may be moved between the stowed position P1 and the deployed position P2 by a structure other than the pivot structure, such as a sliding structure. In this case, the rear seat is slidably moved in the front-rear direction. The rear seat 40 may be moved between the stowed position and the deployed position by a detachment structure of the rear seat, for example. In this case, the rear seat at the stowed position is once dismounted and moved to the deployed position. The rear seat may be mounted, at the deployed position, to a mount different from a mount at the stowed position. As described above, the rear seat 40 is only required to have a structure that functions as a seat on which an occupant is seated when located at the stowed position P1 and functions as a portion of the cargo bed when located at the deployed position P2.

As illustrated in FIGS. 1 and 2, the rear backrest 48 does not follow movement of the rear seating surface 42 in the rear seat 40. In the rear seat 40, the rear backrest 48 is not rotated when the rear seating surface 42 is rotated around the rotational axis. Similarly, the rear armrest 49 does not follow movement of the rear seating surface 42 in the rear seat 40. In the rear seat 40, the rear armrest 49 is not rotated when the rear seating surface 42 is rotated around the rotational axis.

The rear seat 40 includes a loading surface 44 facing opposite the rear seating surface 42. The loading surface 44 faces downward with the rear seat 40 at the deployed position P2. The loading surface 44 faces upward with the rear seat 40 at the deployed position P2. Cargo can be placed on the loading surface 44 with the rear seat 40 at the deployed position P2.

In the present embodiment, a seat portion of the rear seat 40 includes a first member 41 including the rear seating surface 42 and a second member 43 overlapping the first member 41. The first member 41 is located above the second member 43 with the rear seat 40 at the stowed position P1. At the stowed position P1, an upper surface of the first member 41 is the rear seating surface 42. A lower surface of the first member 41 and an upper surface of the second member 43 face each other. The loading surface 44 is a surface forming a lower surface of the second member 43 with the rear seat 40 at the stowed position P1.

The first member 41 includes the rear seating surface 42 on which an occupant is expected to be seated. The first member 41 thus may be a cushioning member to make an occupant comfortable to sit on, for example. The second member 43 includes the loading surface 44 on which an occupant is not expected to be seated. The second member 43 thus may be a member harder or more rigid than the first member 41, for example.

The rear seating surface 42 may be curved in the vertical direction so that an occupant is easily seated thereon. The loading surface 44 may be flatter in the vertical direction than the rear seating surface 42 so that the cargo is easily loaded thereon. The loading surface 44 may be a flat surface parallel to a horizontal direction.

In the present embodiment, the rear seating surface 42 is supported by the vehicle body via the seating surface support frame 29 and the base panel 50. As illustrated in FIG. 8, the seating surface support frame 29 is located above the rear cover 24. The seating surface support frame 29 includes a pair of cross frames 29a, a pair of lateral frames 29b, and a pair of vertical frames 29c, for example. The cross frames 29a are arranged away from each other in the front-rear direction. The cross frames 29a each extend in the vehicle width direction. The lateral frames 29b are arranged away from each other in the vehicle width direction. The lateral frames 29b each extend in the front-rear direction. The vertical frames 29c are arranged away from each other in the vehicle width direction. The vertical frames 29c each extend in the vertical direction.

The vertical frames 29c extend upward from a left side and a right side of the floor. A rear cross frame 29a connects upper ends of the vertical frames 29c. The lateral frames 29b extend forward from a bottom of the rear cross frame 29a. A front cross frame 29a connects front portions of the lateral frames 29b.

Front ends of the lateral frames 29b may be connected to the rear cover 24. As illustrated in FIG. 9, the rear cover 24 may have frame supports 24c that support the front ends of the lateral frames 29b.

The base panel 50 is supported by the seating surface support frame 29. The base panel 50 covers the seating surface support frame 29. The base panel 50 is located below the rear seat 40 located at the stowed position P1. The rear seat 40 has a region in which the rear seat 40 horizontally overlaps the base panel 50 when located at the stowed position P1. In the present embodiment, the rear seat 40 as a whole horizontally overlaps the base panel 50 when located at the stowed position P1. The rear seat 40 is smaller than the base panel 50 in plan view with the rear seat 40 located at the stowed position P1. The rear seat 40 as a whole is located within a region surrounded by an outer edge of the base panel 50 in plan view with the rear seat 40 located at the stowed position P1.

The base panel 50 is exposed upward with the rear seat 40 located at the deployed position P2. The rear seat 40 expands to a region horizontally different from the base panel 50 while located at the deployed position P2. In the present embodiment, the rear seat 40 as a whole expands to a region different from the base panel 50 while located at the deployed position P2. At least portion of the rear seat 40 is only required to expand to a region different from the base panel 50 while located at the deployed position P2.

As illustrated in FIG. 4, the base panel 50 includes, in an upper surface thereof, the frame 51 and a lid 52 supported to be openable relative to the frame 51. A storage space S is located below the lid 52.

The frame 51 includes a front wall 51a, side walls 51b, and a main plate 51c. The front wall 51a is a front portion of the frame 51. The front wall 51a extends in the vehicle width direction. The side walls 51b are a left portion and a right portion of the frame 51. The side walls 51b each extend in the front-rear direction. A front end of a left side wall 51b is connected to a left end in the vehicle width direction of the front wall 51a. A front end of a right side wall 51b is connected to a right end in the vehicle width direction of the front wall 51a. The main plate 51c is a portion surrounded by the front wall 51a and the left and right side walls 51b. The front wall 51a and the side walls 51b protrude above the main plate 51c. The lid 52 is located at the center of the main plate 51c. There is an unillustrated opening at the center of the main plate 51c of the frame 51 and below the lid 52. The opening of the frame 51 has a size corresponding to a space surrounded by the pair of cross frames 29a and the pair of lateral frames 29b.

The lid 52 closes the opening of the frame 51. A user can access the storage space S through the opening of the frame 51 with the lid 52 open. The lid 52 is hinged or slid and may be able to open and close the opening of the frame 51 while mounted to the frame 51. The lid 52 is detachably attached to the frame 51 and may be able to open and close the opening of the frame 51 by being attached and detached.

There is no wall like the front wall 51a in a rear portion of the main plate 51c. The rear seat 40 is connected to a rear edge of the main plate 51c of the frame 51 via a hinge 53. The second member 43 of the rear seat 40 is connected to the hinge 53. An edge portion of the second member 43 connected to the hinge 53 is a rear edge of the second member 43 with the rear seat 40 at the stowed position P1 and is a front edge of the second member 43 with the rear seat 40 at the deployed position P2. The hinge 53 is one example of a pivotal support located in a rear portion of the rear seat 40 at the stowed position PI and capable of angularly displacing the rear seat 40.

The rear edge of the main plate 51c may be located forward of rear ends of the side walls 51b. The front edge of the second member 43 may be located forward of the rear ends of the side walls 51b with the rear seat 40 deployed.

An upper surface of the main plate 51c is hidden by the rear seat 40 with the rear seat 40 at the stowed position P1. The upper surface of the main plate 51c appears with the rear seat 40 at the deployed position P2 rotated 180°from the stowed position P1. With the rear seat 40 at the deployed position P2, the main plate 51c functions, together with the rear seat 40, as the cargo bed on which the cargo can be loaded. The upper surface of the main plate 51c may be flush with the loading surface 44 of the rear seat 40 with the rear seat 40 at the deployed position P2 rotated 180°from the stowed position P1.

The rear seat 40 includes handles 45 located opposite the hinge 53. Specifically, the handles 45 are located forward of the hinge 53 with the rear seat 40 located at the stowed position P1. The handles 45 are located rearward of the hinge 53 with the rear seat 40 located at the deployed position P2. The handles 45 herein protrude from the second member 43. The handles 45 protrude rearward from the rear edge of the second member 43 with the rear seat 40 at the deployed position P2. The handles 45 protrude forward from the front edge of the second member 43 with the rear seat 40 at the stowed position P1.

The frame 51 includes recesses 51d in which the handles 45 of the rear seat 40 at the stowed position Pl are arranged. The main plate 51c is herein recessed from the front wall 51a and the side walls 51b. An outer edge of the main plate 51c has a shape corresponding to outer shapes of the second member 43 and the handles 45. The second member 43 and the handles 45 are stored in a space surrounded by the front wall 51a and the side walls 51b with the rear seat 40 at the stowed position P1. A rear edge of the front wall includes the recesses 51d in which the handles 45 protruding from the second member 43 are stored. Height dimensions of the front wall 51a and the side walls 51b may each substantially be the same as a thickness dimension of the second member 43, for example. The thickness dimension of the second member 43 is a dimension of the second member 43 in a direction in which the first member 41 and the second member 43 overlap each other. The recesses 51d are preferably spaced apart from the handles 45, specifically, by 50 mm or more in the front-rear direction with the rear seat 40 at the stowed position P1. The handles 45 can thus be gripped while interference with the recesses 51d is prevented.

The user can access the handles 45 with the handles 45 stored in the recesses 51d. The handles 45 may each have a U shape, for example. One end and the other end of the U shape may be connected to an outer edge of the second member 43. A portion between the one end and the other end of the U shape may be away from the outer edge of the second member 43.

The rear armrest 49 is connected to the frame 51. In an example illustrated in FIG. 4, lower ends of rear portions of rear armrests 49 are connected to rear ends of the side walls 51b of the frame 51. Lower ends of front portions of the rear armrests 49 are connected to junctions between end portions along the vehicle width direction of the front wall 51a of the frame 51 and front ends of the side walls 51b.

The partition mount is located to allow the partition fence extending in the vehicle width direction to be disposed. The partition mount is located to allow the partition fence to be disposed in a rear portion of the rear seat 40 at the deployed position P2. The partition mount is located to allow the partition fence to be disposed in an outer portion in the vehicle width direction of the rear seat 40 at the deployed position P2. The partition mount is located to allow the partition fence to be disposed in the rear portion and in opposite outer side portions in the vehicle width direction of the rear seat 40 at the deployed position P2.

The partition mount includes a rear seat partition mount located at the rear seat 40. The rear seat partition mount is located at an upper surface (herein the loading surface 44) of the rear seat 40 at the deployed position P2. The rear seat partition mount is at a different position from the rear seating surface 42 of the rear seat 40. The rear seat partition mount is at a surface opposite the rear seating surface 42 of the rear seat 40. The rear seat partition mount is at a position adjacent to the loading surface 44. The rear seat partition mount may include rear seat partition mounts spaced apart in the vehicle width direction or in the front-rear direction. In the present embodiment, the rear seat partition mount is at a position at which the rear seat partition mount overlaps the rear footrest 28 in top view.

Fixing holes 47 as rear seat partition mounts are herein in an edge portion of the second member 43. The fixing holes 47 are in a left edge portion and in a right edge portion of the second member 43. In the present embodiment, the fixing holes 47 are located in the middle in the front-rear direction of the second member 43. The fixing holes 47 are hidden with the rear seat 40 located at the stowed position P1. The fixing holes 47 appear with the rear seat 40 located at the deployed position P2. The fixing holes 47 can be hidden when not in use.

The fixing holes 47 are holes to fix the partition fence to the rear seat 40. For example, the partition fence can be mounted to the holes using clamps 90. The fixing holes 47 extend through the loading surface 44 of the second member 43. The fixing holes 47 are shaped to allow passage of retaining parts 94 of the clamps 90, which will be described below, but not to allow passage of bases 92 of the clamps 90. In the present embodiment, the fixing holes 47 are elongated holes.

FIG. 5 illustrates the fence 70 as one example of the partition fence. The fence 70 includes a left fence portion 71, a right fence portion 72, and a rear fence portion 73. The left fence portion 71 is disposed to extend in the front-rear direction along a left edge of the loading surface 44. The right fence portion 72 is disposed to extend in the front-rear direction along a right edge of the loading surface 44. The rear fence portion 73 is disposed to extend in the vehicle width direction along a rear edge of the loading surface 44. A left end of the rear fence portion 73 and a rear end of the left fence portion 71 are connected. A right end of the rear fence portion 73 and a rear end of the right fence portion 72 are connected. The fence 70 as the partition fence has a configuration as described above, so that a fall outward in the vehicle width direction of the cargo disposed in the cargo bed space from the second member 43 and a rearward fall of the cargo from the second member 43 can be prevented.

Fixing holes 74 are in the left fence portion 71 and in the right fence portion 72. The left fence portion 71 includes a lower plate 71a facing the loading surface 44. The right fence portion 72 includes a lower plate 72a facing the loading surface 44. The lower plates 71a and 72a are in the form of elongated plates. The fixing holes 74 are in intermediate portions in a direction of extension of the lower plates 71a and 72a. The fixing holes 74 are shaped to allow passage of the retaining parts 94 of the clamps 90 but not to allow passage of the bases 92 of the clamps 90. The fixing holes 74 may have the same shapes as the fixing holes 47.

Spacing between the two lower plates 71a and 72a is set to have a size corresponding to spacing between the two fixing holes 47 in the loading surface 44. The lower plates 71a and 72a are arranged above the respective two fixing holes 47 in the loading surface 44, so that the two fixing holes 74 can be arranged above the respective two fixing holes 47. In this state, the clamps 90 are inserted and locked into the fixing holes 47 and 74, so that the fence 70 can be fixed to the loading surface 44. One example of each of the clamps 90 will be described.

The clamp 90 is attached to and detached from each of the fixing holes 47 and 74 by quick operation. Quick operation is herein operation simpler than thread fastening operation or thread unfastening operation and is a combination of two unidirectional operations or one unidirectional operation, for example. The unidirectional operation is operation in one direction unaccompanied by returning operation and may be rotational operation, pushing operation, pulling operation, pushing-up operation, pushing-up operation, and lateral movement operation. For example, rotational operation in one direction unaccompanied by returning operation is operation that can be performed by one twist of the wrist and is rotational operation of 180° or less, for example. Quick operation is preferably operation that can be performed without using any tool but is not necessarily required to be operation that can be performed without using any tool. For example, quick operation may be performed using a tool having a key function.

For example, as illustrated in FIG. 7, the clamp 90 includes the base 92, the retaining part 94, a shaft 96, and an operating part 98.

The base 92 is sized to be unable to pass through each of the fixing holes 47 and 74 regardless of an orientation relative to each of the fixing holes 47 and 74. For example, the base 92 is sized to be longer than a direction of extension of each of the elongated fixing holes 47 and 74 and to be thicker than a width of each of the fixing holes 47 and 74.

The retaining part 94 is sized to be able to pass or unable to pass through each of the fixing holes 47 and 74 depending on an orientation relative to each of the fixing holes 47 and 74. For example, the retaining part 94 is sized to be long along the direction of extension of each of the elongated fixing holes 47 and 74 and to be smaller than each of the elongated fixing holes 47 and 74. The length of the retaining part 94 is greater than the width of each of the elongated fixing holes 47 and 74. With a direction of extension of the retaining part 94 oriented along the direction of extension of each of the fixing holes 47 and 74, the retaining part 94 can pass through each of the fixing holes 47 and 74. With the direction of extension of the retaining part 94 oriented to cross the direction of extension of each of the fixing holes 47 and 74, the retaining part 94 cannot pass through each of the fixing holes 47 and 74.

The shaft 96 connects the base 92 and the retaining part 94 to be rotatable relative to each other. The retaining part 94 is rotatable relative to the base 92 around a central axis of the shaft 96. There is a gap between the base 92 and the retaining part 94. The gap is sized so that a peripheral edge of each of the fixing holes 47 of the second member 43 and a peripheral edge of each of the fixing holes 74 of the lower plates 71a and 72a of the fence 70 can be sandwiched.

The clamp 90 may have an unillustrated urging member, such as a spring. The retaining part 94 may be urged toward the base 92 by the urging member. Spacing between the retaining part 94 and the base 92 is thus adjusted depending on a thickness of a portion to be sandwiched between the base 92 and the retaining part 94.

The operating part 98 is located opposite the retaining part 94 with the base 92 therebetween. That is to say, the base 92 is located between the operating part 98 and the retaining part 94. The operating part 98 is connected not to be rotatable relative to the shaft 96. The operating part 98 may have an elongated shape to facilitate rotational operation. The operating part 98 is rotated around the central axis of the shaft 96 relative to the base 92 to rotate the retaining part 94 around the central axis of the shaft 96 relative to the base 92.

For example, in an attachable and detachable state, the retaining part 94 extends along a direction of extension of the base 92, and the operating part 98 extends to cross the direction of extension of the base 92. In this state, the retaining part 94 passes through each of the fixing holes 47 and 74 and is disposed opposite the base 92.

The operating part 98 is then rotated to cause the retaining part 94 to extend to cross the direction of extension of the base 92 and to cause the operating part 98 to extend along the direction of extension of the base 92. The retaining part 94 can thus no longer pass through each of the fixing holes 47 and 74, and the base 92 and the retaining part 94 sandwich the peripheral edge of each of the fixing holes 47 of the second member 43 and the peripheral edge of each of the fixing holes 74 of the lower plates 71a and 72a of the fence 70. The fence 70 is thus fixed to the rear seat 40 using the clamps 90.

That is to say, the operating part 98 is a part to operate the retaining part 94 to a state in which the retaining part 94 can pass through each of the fixing holes 47 and 74 and a state in which the retaining part 94 is retained from each of the fixing holes 47 and 74.

To hold the above-mentioned fixing state, one of the base 92 and the operating part 98 may have a protrusion 92a, and the operating part 98 may have a recess 98a into which the protrusion 92a fits. The protrusion 92a fits into the recess 98a in the fixing state to suppress rotation of the operating part 98 and the retaining part 94 relative to the base 92 and maintain the fixing state.

In the present embodiment, the partition mount includes a footrest partition mount located at the rear footrest 28. The brackets 28a at the rear footrest 28 are herein examples of the footrest partition mount. The guard 60 is one example of the partition fence mounted to the footrest partition mount. The guard 60 includes a pair of left and right vertical pipes 61 and 62 each extending in the vertical direction and a pair of upper and lower lateral pipes 63 and 64 each extending in the vehicle width direction. The upper lateral pipe 63 connects upper ends of the vertical pipes 61 and 62. The lower lateral pipe 64 connects intermediate portions of the vertical pipes 61 and 62. For example, the vertical pipes 61 and 62 and the lateral pipe 63 may be members obtained by bending a single pipe. The lateral pipe 64 may be connected to the vertical pipes 61 and 62 by welding, fastening, or the like. Mounts 65 to be mounted to the brackets 28a are located at lower ends of the vertical pipes 61 and 62 of the guard 60. For example, the brackets 28a and the mounts 65 may be mounted by fastening members, such as bolts B. As illustrated in FIG. 4, upper portions of the vertical pipes 61 and 62 and the lateral pipe 63 of the guard 60 are located in a rear portion of the loading surface 44 and partition the rear portion of the loading surface 44 with the rear seat 40 at the deployed position P2.

The handles 45 may be located lateral to the guard 60 with the rear seat 40 at the deployed position P2. The handles 45 may be located outward in the vehicle width direction of the guard 60 with the rear seat 40 at the deployed position P2. A left handle 45 may be located to the left of the left vertical pipe 61. A right handle 45 may be located to the right of the right vertical pipe 62.

The handles 45 may be located close to the guard 60 with the rear seat 40 at the deployed position P2. Spacing between the left handle 45 and the left vertical pipe 61 may be smaller than a dimension of the handle 45 along the vehicle width direction. Spacing between the right handle 45 and the right vertical pipe 62 may be smaller than a dimension of the handle 45 along the vehicle width direction.

The second member 43 may have a protrusion 46 protruding in the same direction as the handles 45. The protrusion 46 may be located between the two handles 45. The protrusion 46 may be located between the two vertical pipes 61 and 62 of the guard 60 with the rear seat 40 at the deployed position P2. A dimension of the protrusion 46 along the vehicle width direction may be the same as or smaller than spacing between the two vertical pipes 61 and 62 of the guard 60. The protrusion 46 may be supported by the lower lateral pipe 64 of the guard 60 with the rear seat 40 at the deployed position P2. Opposite end portions along the front-rear direction of the rear seat 40 can thus be supported with a front end of the second member 43 supported by the hinge 53 and a rear end of the second member 43 supported by the lateral pipe 64.

When the rear seat 40 is moved from the stowed position P1 to the deployed position P2, the protrusion 46 and the lateral pipe 64 can collide with each other. The protrusion 46 or the lateral pipe 64 may have a damper as a buffering member that reduces the impact from the collision. The damper may be realized with gum or rubber.

In the present embodiment, the partition mount includes a rail structure 25. The rail structure 25 is located at the rear cover 24. The rail structure 25 may be located at a portion other than the rear cover 24.

The rail structure 25 is located at the intermediate cover portion 24b of the rear cover 24. The intermediate cover portion 24b includes an upper cover portion 24b1, a rear cover portion 24b2, and a lower cover portion 24b3 as illustrated in FIG. 8, for example. The upper cover portion 24b1 covers the motor 18 from above. The rear cover portion 24b2 extends downward from a rear end of the upper cover portion 24b1. The rear cover portion 24b2 covers the motor 18 from behind. The lower cover portion 24b3 extends rearward from a lower end of the rear cover portion 24b2. The lower cover portion 24b3 covers a rear end of a bottom frame of the floor, for example.

As illustrated in FIG. 9, the rail structure 25 is located at the upper cover portion 24b1 of the intermediate cover portion 24b. The rail structure 25 includes a fixing groove 25a and a pair of locking walls 25b. A top of the fixing groove 25a is open. The pair of the locking walls 25b makes a top opening 25al of the fixing groove 25a narrower than a bottom 25a2 of the fixing groove 25a. The locking walls 25b protrude from side walls of the fixing groove 25a. The clamp 90 can be fixed at any position of the rail structure 25.

The top opening 25al is sized not to allow passage of the base 92 of the clamp 90. As shown by the clamp 90 in phantom lines in FIG. 9, the top opening 25al is sized to allow passage of the retaining part 94 of the clamp 90 with the retaining part 94 along the direction of extension of the base 92. As shown by the clamp 90 in solid lines in FIG. 9, the top opening 25al is sized not to allow passage of the retaining part 94 with the retaining part 94 along a direction crossing the direction of extension of the base 92. With the retaining part 94 located at the bottom 25a2 of the fixing groove 25a, the operating part 98 is operated, so that the retaining part 94 can be locked to the locking walls 25b. With the retaining part 94 along the direction of extension of the base 92, the clamp may be insertable into the fixing groove 25a through the top opening 25al at any position along the direction of extension of the fixing groove 25a. The clamp 90 can thus be fixed at any position along the direction of extension of the fixing groove 25a.

A rear end of the fixing groove 25a is open to the rear cover portion 24b2 of the rear cover 24. The clamp 90 is insertable into the fixing groove 25a from a rear opening of the fixing groove 25a in the rear cover portion 24b2. The clamp 90 can be moved along the direction of extension of the fixing groove 25a with the retaining part 94 along the direction of extension of the base 92. The clamp 90 can thus also be fixed at any position along the direction of extension of the fixing groove 25a.

A space rearward of the rear cover portion 24b2 and above the lower cover portion 24b3 of the intermediate cover portion 24b may be the storage space S. A front portion of the storage space S is partitioned by the rear cover portion 24b2. Portions outward in the vehicle width direction of the storage space S are partitioned by the wheelhouses 24a. A lower portion of the storage space S is partitioned by the lower cover portion 24b3. There may be no wall in a rear portion of the storage space S. The user may be accessible to the storage space S from below and behind the rear seat 40 with the rear seat 40 at the stowed position P1. It is difficult to access the storage space S from below the rear seat 40 with the rear seat 40 at the deployed position P2. The lid 52 facilitates access to the storage space S even with the rear seat 40 at the deployed position P2. There may be a wall in the rear portion of the storage space S. The base panel 50 may have a rear wall of the storage space S.

In the present embodiment, the partition mount includes a panel partition mount located at the base panel 50. Fixing holes 54 as panel partition mounts are herein in the base panel 50. The fixing holes 54 are holes to which the clamps 90 can be fixed as with the above-mentioned fixing holes 47. The fixing holes 54 are herein in the frame 51. The fixing holes 54 are in an upper surface of the front wall 51a of the frame 51. Two fixing holes 54 are located away from each other along the vehicle width direction.

In the present embodiment, the partition mount includes an outer wall partition mount. A pair of outer walls is located on opposite sides in the vehicle width direction of the rear seat 40 with the rear seat 40 located at the stowed position P1. Partition mounts are located at the outer walls to allow the partition fence to be suspended in the vehicle width direction. The pair of rear armrests 49 is herein one example of the pair of outer walls. As illustrated in FIG. 11, fixing grooves 49a are in the rear armrests 49. The fixing grooves 49a are examples of the outer wall partition mount.

For example, the fixing grooves 49a are at the same position along the front-rear direction in the left and right rear armrests 49. The partition wall 80 is inserted into the fixing grooves 49a. The partition wall 80 is a member in the form of a flat plate. The partition wall 80 inserted into the fixing grooves 49a is oriented along a flat surface crossing the front-rear direction.

As illustrated in FIG. 11, grooves may be at positions along the front-rear direction in each of the rear armrests 49. A groove may be only at one position along the front-rear direction in each of the rear armrests 49.

### Effects and Others

According to the vehicle 10 having a configuration as described above, the cargo bed space can be expanded using the rear seat 40 at the deployed position P2. The partition fences 60, 70, and 80 mounted to the partition mounts 25, 28a, 47, 49a, and 54 can prevent a fall of a load loaded in the expanded cargo bed space. At least one or more of the partition fences 60, 70, and 80 are dismounted from the vehicle body, so that interference of the partition fences 60, 70, and 80 with an occupant can be prevented in a case where the rear seat 40 is moved to the stowed position P1.

The partition mounts 25, 28a, 47, 49a, and 54 are located to allow the partition fences 60, 70, and 80 extending in the vehicle width direction to be arranged. The partition fences 60, 70, and 80 can prevent forward and rearward movement of the load. For example, movement of the load attributable to acceleration and deceleration of the vehicle 10 is likely to be prevented.

The partition mounts 47 are located to allow the partition fence 70 to be disposed in the rear portion of the rear seat 40 at the deployed position P2. The partition fence 70 is disposed in the rear portion, so that a dimension in the front-rear direction of the cargo bed space in which a fall is prevented can be increased.

The partition mounts 47 are located to allow the partition fence 70 to be disposed in the outer portion in the vehicle width direction of the rear seat 40 at the deployed position P2. The partition fence 70 is disposed in the outer portion in the vehicle width direction, so that a dimension in the vehicle width direction of the cargo bed space in which the fall is prevented can be increased.

The partition mounts 47 are located to allow the partition fence 70 to be disposed in the rear portion and in the opposite outer side portions in the vehicle width direction of the rear seat 40 at the deployed position P2. The partition fence 70 is disposed, so that both a rearward fall and a lateral fall of the load can be prevented.

The partition mounts 47 are located at the upper surface 44 of the rear seat 40 at the deployed position P2. The partition fence 70 can be disposed close to the expanded cargo bed space.

The rear seat 40 includes the seating surface 42 which faces upward and on which an occupant is seated at the stowed position P1, and the partition mounts 47 are at different positions from the seating surface 42. Uncomfortableness upon being seated is prevented, and mounting of the partition fence 70 can be facilitated.

The partition mounts 47 are at the surface opposite the seating surface 42 of the rear seat 40. The partition mounts 47 appear with the rear seat 40 deployed and are hidden with the rear seat 40 stowed.

The rear seat 40 includes the seating surface 42 which faces upward and on which an occupant is seated at the stowed position P1 and the loading surface 44 which faces upward and on which the cargo is loaded at the deployed position P2, and the partition mounts 47 are at positions adjacent to the loading surface 44. The partition fence 70 is easily mounted close to the loading surface 44.

The base panel 50 located below the rear seat 40 located at the stowed position P1 is further included, and the base panel 50 is exposed upward with the rear seat 40 located at the deployed position P2. The cargo bed space can be expanded using both the rear seat 40 and the base panel 50 with the rear seat 40 located at the deployed position P2. The partition fence 70 mounted to the partition mounts 47 can prevent the fall of the load loaded in the expanded cargo bed space.

The pair of rear armrests 49 located on opposite sides in the vehicle width direction of the rear seat 40 with the rear seat 40 located at the stowed position P1 is included, and the partition mounts 49a are located at the rear armrests 49 to allow the partition fence 80 to be suspended in the vehicle width direction. The partition fence is easily mounted to parts located lateral to the cargo bed.

The vehicle 10 includes the rear footrest 28 located rearward of the rear seat 40 located at the stowed position P1 and located below the rear seat 40, and the partition mounts 28a are located at the rear footrest 28. The partition fence 60 is disposed in the rear portion, so that the dimension in the front-rear direction of the cargo bed space in which the fall is prevented can be increased.

The vehicle 10 includes the hinge 53 located in the rear portion of the rear seat 40 at the stowed position P1 and capable of angularly displacing the rear seat 40, and the rear seat 40 includes the handles 45 located opposite the hinge 53. The rear seat 40 can angularly be displaced while the handles 45 are held.

The vehicle 10 includes the recesses 51d in which the handles 45 of the rear seat 40 at the stowed position P1 are arranged. The recesses 51d facilitate gripping of the handles 45 even with the rear seat 40 stowed.

The base panel 50 includes, in the upper surface thereof, the frame 51 and the lid 52 supported to be openable relative to the frame 51, and the storage space S is located below the lid 52. The storage space S can be used by opening and closing the lid 52.

The partition mounts 25, 28a, 47, 49a, and 54 each include the rail structure 25. The partition fences 60, 70, and 80 can each be mounted at any position in a direction of extension of the rail.

### Appendices

The vehicle may be a conveyance other than the PTV. For example, the vehicle may be a low speed vehicle (LSV), a neighborhood electric vehicle (NEV), and the like.

A drive source is not limited to the motor and may be the internal combustion engine.

The partition fence is only required to be detachably attached to the vehicle body, and another detachment structure may be used. For example, the partition fence may have a fitting structure fitted to the partition mount. The fitting structure may be a structure in which one of the partition wall and the partition mount has a protrusion and the other one of the partition wall and the partition mount has a recess. The partition fence may detachably be fixed to the vehicle body by a bolt, a rivet, and the like.

The partition fence may have a folding structure. The partition fence folded to be reduced in size may be mounted to the vehicle body. The vehicle body may include a holder that holds the partition fence folded to be reduced in size.

The partition fence may be in the form of a board and a net. The partition fence is only required to have a structure to prevent a fall of the cargo while disposed at the deployed position P2. The partition fence may have a structure to prevent a rearward fall of the cargo or may have a structure to prevent a fall outward in the left-right direction.

The partition mount may be at the rear edge of the second member 43. The partition mount may include partition mounts located at the rear edge of the second member 43 and spaced apart in the vehicle width direction. End portions outward in the vehicle width direction of the rear seat 40 at the deployed position P2 face the rear entrances. The partition wall is preferably located to prevent a fall of the cargo from the rear entrances. The partition fence may be disposed not only to prevent the fall of the cargo but also to prevent movement of the cargo in the cargo bed space.

The partition fence preferably prevents rearward movement of the cargo and movement outward in the left-right direction of the cargo but may have a structure to prevent movement of the cargo in one of these directions.

The partition mount may be located at a position other than the rear seat. For example, the partition mount may be located at the armrests, the guard, and the rear footrest.

Configurations described in the above-mentioned embodiment and modifications can be combined with each other as appropriate unless any contradiction occurs.

The specification and the drawings disclose the following aspects.

A vehicle according to a first aspect includes: a front footrest; a front seat located rearward of the front footrest and including a seating surface located above the front footrest; a rear seat including a seating surface located rearward of the front seat, the rear seat being switchable between a stowed position at which an occupant is capable of being seated thereon and a deployed position located rearward of the stowed position; and a partition mount to which a partition fence that partitions the rear seat at the deployed position is mountable.

According to the first aspect, the cargo bed space can be expanded using the rear seat at the deployed position. The partition fence mounted to the partition mount can prevent the fall of the load loaded in the expanded cargo bed space.

A second aspect is the vehicle according to the first aspect, wherein the partition mount is located to allow the partition fence extending in a vehicle width direction to be disposed. The partition fence can prevent forward and rearward movement of the load. For example, movement of the load attributable to acceleration and deceleration of the vehicle is likely to be prevented.

A third aspect is the vehicle according to the first or the second aspect, wherein the partition mount is located to allow the partition fence to be disposed in a rear portion of the rear seat at the deployed position. The partition fence is disposed in the rear portion, so that the dimension in the front-rear direction of the cargo bed space in which the fall is prevented can be increased.

A fourth aspect is the vehicle according to any one of the first to the third aspects, wherein the partition mount is located to allow the partition fence to be disposed in an outer portion in a vehicle width direction of the rear seat at the deployed position. The partition fence is disposed in the outer portion in the vehicle width direction, so that the dimension in the vehicle width direction of the cargo bed space in which the fall is prevented can be increased.

A fifth aspect is the vehicle according to any one of the first to the fourth aspects, wherein the partition mount is located to allow the partition fence to be disposed in a rear portion and in opposite outer side portions in a vehicle width direction of the rear seat at the deployed position. The partition fence is disposed, so that both the rearward fall and the lateral fall of the load can be prevented.

A sixth aspect is the vehicle according to any one of the first to the fifth aspects, wherein the partition mount is located at an upper surface of the rear seat at the deployed position. The partition fence can be disposed close to the expanded cargo bed space.

A seventh aspect is the vehicle according to any one of the first to the sixth aspects, wherein the rear seat includes a seating surface which faces upward and on which an occupant is seated at the stowed position, and the partition mount is at a different position from the seating surface. Uncomfortableness upon being seated is prevented, and mounting of the partition fence can be facilitated.

An eighth aspect is the vehicle according to the seventh aspect, wherein the partition mount is at a surface opposite the seating surface of the rear seat. The partition mount appears with the rear seat deployed and is hidden with the rear seat stowed.

A ninth aspect is the vehicle according to any one of the first to the eighth aspects, wherein the rear seat includes a seating surface which faces upward and on which an occupant is seated at the stowed position and a loading surface which faces upward and on which cargo is loaded at the deployed position, and the partition mount is at a position adjacent to the loading surface. The partition fence is easily mounted close to the loading surface.

A tenth aspect is the vehicle according to any one of the first to the ninth aspects, further comprising a base panel located below the rear seat located at the stowed position, wherein the base panel is exposed upward with the rear seat located at the deployed position. The cargo bed space can be expanded using both the rear wall and the base panel with the rear seat located at the deployed position. The partition fence mounted to the partition mount can prevent the fall of the load loaded in the expanded cargo bed space.

An eleventh aspect is the vehicle according to any one of the first to the tenth aspects, further comprising a pair of outer walls located on opposite sides in a vehicle width direction of the rear seat with the rear seat located at the stowed position, wherein the partition mount is located at each of the outer walls to allow the partition fence to be suspended in a vehicle width direction. A partition is easily mounted to parts laterally located.

A twelfth aspect is the vehicle according to any one of the first to the eleventh aspects, further comprising a rear footrest located rearward of the rear seat located at the stowed position and located below the rear seat, wherein the partition mount is located at the rear footrest. The partition fence is disposed in the rear portion, so that the dimension in the front-rear direction of the cargo bed space in which the fall is prevented can be increased.

A thirteenth aspect is the vehicle according to any one of the first to the twelfth aspects, further comprising a pivotal support located in a rear portion of the rear seat at the stowed position and capable of angularly displacing the rear seat, wherein the rear seat includes a handle located opposite the pivotal support. The rear seat can angularly be displaced while the handle is held.

A fourteenth aspect is the vehicle according to the thirteenth aspect, further comprising a recess in which the handle of the rear seat at the stowed position is disposed. The recess facilitates gripping of the handle even with the rear seat stowed.

A fifteenth aspect is the vehicle according to the tenth aspect, wherein the base panel includes, in an upper surface thereof, a frame and a lid supported to be openable relative to the frame, a storage space being located below the lid. The storage space can be used by opening and closing the lid.

A sixteenth aspect is the vehicle according to any one of the first to the fifteenth aspects, wherein the partition mount includes a rail structure. The partition fence can be mounted at any position in the direction of extension of the rail.

The foregoing description is in all aspects illustrative and not restrictive. It is therefore understood that numerous unillustrated modifications can be devised without departing from the scope of the invention.

1. A vehicle comprising:
a front footrest;
a front seat located rearward of the front footrest and including a seating surface located above the front footrest;
a rear seat including a seating surface located rearward of the front seat, the rear seat being switchable between a stowed position at which an occupant is allowed to be seated thereon and a deployed position located rearward of the stowed position; and
a partition mount to which a partition fence that partitions the rear seat at the deployed position is mountable.

2. The vehicle according to claim 1, wherein
the partition mount is located to allow the partition fence extending in a vehicle width direction to be disposed.

3. The vehicle according to claim 1, wherein
the partition mount is located to allow the partition fence to be disposed in a rear portion of the rear seat at the deployed position.

4. The vehicle according to claim 1, wherein
the partition mount is located to allow the partition fence to be disposed in an outer portion in a vehicle width direction of the rear seat at the deployed position.

5. The vehicle according to claim 1, wherein
the partition mount is located to allow the partition fence to be disposed in a rear portion and in opposite outer side portions in a vehicle width direction of the rear seat at the deployed position.

6. The vehicle according to claim 1, wherein
the partition mount is located at an upper surface of the rear seat at the deployed position.

7. The vehicle according to claim 1, wherein
the rear seat includes a seating surface which faces upward and on which an occupant is seated at the stowed position, and the partition mount is at a different position from the seating surface.

8. The vehicle according to claim 7, wherein
the partition mount is at a surface opposite the seating surface of the rear seat.

9. The vehicle according to claim 1, wherein
the rear seat includes a seating surface which faces upward and on which an occupant is seated at the stowed position and a loading surface which faces upward and on which cargo is loaded at the deployed position, and
the partition mount is at a position adjacent to the loading surface.

10. The vehicle according to claim 1, further comprising
a base panel located below the rear seat located at the stowed position, wherein
the base panel is exposed upward with the rear seat located at the deployed position.

11. The vehicle according to claim 1, further comprising
a pair of outer walls located on opposite sides in a vehicle width direction of the rear seat with the rear seat located at the stowed position, wherein
the partition mount is located at each of the outer walls to allow the partition fence to be suspended in a vehicle width direction.

12. The vehicle according to claim 1, further comprising
a rear footrest located rearward of the rear seat located at the stowed position and located below the rear seat, wherein
the partition mount is located at the rear footrest.

13. The vehicle according to claim 1, further comprising
a pivotal support located in a rear portion of the rear seat at the stowed position and allowing angular displacement of the rear seat, wherein
the rear seat includes a handle located opposite the pivotal support.

14. The vehicle according to claim 13, further comprising
a recess in which the handle of the rear seat at the stowed position is disposed.

15. The vehicle according to claim 10, wherein
the base panel includes, in an upper surface thereof, a frame and a lid supported to be openable relative to the frame, a storage space being located below the lid.

16. The vehicle according to claim 1, wherein
the partition mount includes a rail structure.
